(19) United States
(12) Patent Application Publication
(10) Pub. No.: US 2013/0088196 A1
(43) Pub. Date: Apr. 11, 2013

(54) HIGH-VOLTAGE BATTERY CHARGING SYSTEM AND CHARGER WITH SUCH CHARGING SYSTEM

(71) Applicants: Chin-Hou Chen, Taoyuan Hsien (TW); Bo-Wen Tang, Taoyuan Hsien (TW); Meng-Fu Cho, Taoyuan Hsien (TW)

(72) Inventors: Chin-Hou Chen, Taoyuan Hsien (TW); Bo-Wen Tang, Taoyuan Hsien (TW); Meng-Fu Cho, Taoyuan Hsien (TW)

(73) Assignee: DELTA ELECTRONICS, INC., Taoyuan Hsien (TW)

(21) Appl. No.: 13/372,188

(22) Filed: Feb. 13, 2012

(30) Foreign Application Priority Data
Oct. 11, 2011 (CN) 201110314943.8

(51) Int. Cl. H02J 7/00

(52) U.S. Cl. 320/109; 320/137

(57) ABSTRACT

A high-voltage battery charging system includes a rectifier circuit, a power factor correction circuit, a bus capacitor, an intermediate non-isolated DC-DC converting circuit, an intermediate output capacitor, and a non-isolated DC-DC converting circuit. The rectifier circuit is used for rectifying an AC input voltage into a rectified voltage. The power factor correction circuit is used for increasing a power factor of the rectified voltage and generating a bus voltage. The bus capacitor is used for energy storage and voltage stabilization. The intermediate non-isolated DC-DC converting circuit is used for boosting the bus voltage into an intermediate output voltage. The intermediate output capacitor is connected between an output terminal of the intermediate non-isolated DC-DC converting circuit and the common terminal COM for energy storage and voltage stabilization. The non-isolated DC-DC converting circuit is used for converting the intermediate output voltage into a high charging voltage, thereby charging the high-voltage battery unit.

### FIELD OF THE INVENTION

The present invention relates to a high-voltage battery charging system, and more particularly to a high-voltage battery charging system for use in an electric vehicle. The present invention relates to a charger with such a high-voltage battery charging system.

### BACKGROUND OF THE INVENTION

Fossil fuels such as petroleum and coal are widely used in automobiles or power plants for generating motive force or electrical power. As known, burning fossil fuels produces waste gases and carbon oxide. The waste gases may pollute the air. In addition, carbon dioxide is considered to be a major cause of the enhanced greenhouse effect. It is estimated that the world's oils supply would be depleted in the next several decades. The oil depletion may lead to global economic crisis.

Consequently, there are growing demands on clean and renewable energy. Recently, electric vehicles and plug-in hybrid electric vehicles have been researched and developed. Electric vehicles (EV) and plug-in hybrid electric vehicles (PHEV) use electrical generators to generate electricity. In comparison with the conventional gasoline vehicles and diesel vehicles, the electric vehicles and hybrid electric vehicles are advantageous because of low pollution, low noise and better energy utilization. The uses of the electric vehicles and hybrid electric vehicles can reduce carbon dioxide emission in order to decelerate the greenhouse effect.

As known, an electric vehicle or a plug-in hybrid electric vehicle has a built-in battery as a stable energy source for providing electric energy for powering the vehicle. In a case that the electric energy stored in the battery is exhausted, the battery is usually charged by a charger. The conventional charger comprises a power factor correction circuit, a bus capacitor and a DC-DC converting circuit. The power factor correction circuit is used for increasing the power factor of an input voltage and generating a bus voltage. The bus capacitor is connected with the output terminal of the power factor correction circuit for energy storage and voltage stabilization. The DC-DC converting circuit is used for receiving the bus voltage and converting the bus voltage into a high charging voltage, thereby charging a high-voltage battery unit.

Generally, the magnitude of the bus voltage generated by the power factor correction circuit is dependent on the rated voltage value of the bus capacitor, and the range of the high charging voltage outputted from the DC-DC converting circuit is dependent on the magnitude of the bus voltage. For widening the range of the high charging voltage to have the high charging voltage (e.g. 400V) to charge the high-voltage battery unit, the bus voltage should be higher than 450V for example. Consequently, the bus capacitor of the charger should have a higher rated voltage value (e.g. >500V). Since the bus capacitor with the high rated voltage value is difficultly available and costly, it is not easy to widen the range of the high charging voltage.

Moreover, the charger of the conventional electric vehicle or the conventional plug-in hybrid electric vehicle further comprises an auxiliary power circuit. The auxiliary power circuit is connected with the output terminal of the power factor correction circuit for providing electric energy to various controlling units of the electric vehicle. The bus voltage is served as the input voltage of the auxiliary power circuit. If the input voltage received by the power factor correction circuit is abnormal or interrupted, the power factor correction circuit fails to generate the bus voltage. Under this circumstance, the auxiliary power circuit is disabled and fails to provide electric energy to various controlling units, the functions controlled by these controlling units will be lost.

Moreover, the bus capacitor of the charger for the electric vehicle is usually non-replaceable. Once the bus capacitor is damaged or used for a long time, the whole charger should be replaced with a new one in order replace the bus capacitor. In other words, the conventional high-voltage battery charging system is neither cost-effective nor resource-saving.

Therefore, there is a need of providing high-voltage battery charging system for use in an electric vehicle and a charger thereof in order to obviate the drawbacks encountered in the prior art.

### SUMMARY OF THE INVENTION

The present invention provides a high-voltage battery charging system for use in an electric vehicle and also a charger with such a high-voltage battery charging system, in which a wide range of a high charging voltage is provided to charge the high-voltage battery unit. Even if the AC input voltage received by the high-voltage battery charging system is abnormal or interrupted, the high-voltage battery charging system can continuously deliver electric energy to various controlling units, consequently, the reliability of the high-voltage battery charging system is enhanced. Moreover, the bus capacitor is replaceable.

In accordance with an aspect of the present invention, there is provided a high-voltage battery charging system. The high-voltage battery charging system includes a rectifier circuit, a power factor correction circuit, a bus capacitor, an intermediate non-isolated DC-DC converting circuit, an intermediate output capacitor, and a non-isolated DC-DC converting circuit. The rectifier circuit is connected with a common terminal for rectifying an AC input voltage into a rectified voltage. The power factor correction circuit is connected to the rectifier circuit for increasing a power factor of the rectified voltage and generating a bus voltage. The bus capacitor is connected between an output terminal of the power factor correction circuit and the common terminal for energy storage and voltage stabilization. The intermediate non-isolated DC-DC converting circuit is connected with the output terminal of the power factor correction circuit and the bus capacitor for boosting the bus voltage into an intermediate output voltage. The intermediate output capacitor is connected between an output terminal of the intermediate non-isolated DC-DC converting circuit and the common terminal for energy storage and voltage stabilization. The non-isolated DC-DC converting circuit is connected with the output terminal of the intermediate non-isolated DC-DC converting circuit, the intermediate output capacitor and a high-voltage battery unit for converting the intermediate output voltage into a high charging voltage, thereby charging the high-voltage battery unit.

In accordance with another aspect of the present invention, there is provided a charger for use in an electric vehicle. The charger includes a charger body, a partition plate assembly, and a circuit board. The partition plate assembly is disposed within the charger body, and having a perforation. The circuit board is partially enclosed within the charger body through the partition plate assembly, and includes a first connecting part and the high-voltage battery charging system of the present invention. The bus capacitor of the high-voltage battery charging system, a supporting plate, a covering member and a second connecting part are collaboratively defined as a replaceable bus capacitor module. The supporting plate is disposed on the partition plate assembly. The second connecting part is electrically connected with the bus capacitor and detachably connected with the first connecting part. The covering member is disposed on the supporting plate for sheltering the bus capacitor. The first connecting part is protruded out over the partition plate assembly through the perforation. The first connecting part is connected with the output terminal of the power factor correction circuit and the intermediate non-isolated DC-DC converting circuit. For replacing the bus capacitor, the first connecting part is detached from the second connecting part and the bus capacitor module with a new one.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic circuit block diagram illustrating the architecture of a high-voltage battery charging system according to an embodiment of the present invention;

FIG. 2 is a schematic circuit block diagram illustrating the architecture of a high-voltage battery charging system according to another embodiment of the present invention;

FIG. 3 is a schematic perspective view illustrating the outward appearance of a battery with a high-voltage battery charging system according to the present invention; and

FIG. 4 schematically illustrates a bus capacitor module of the battery as shown in FIG. 3.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

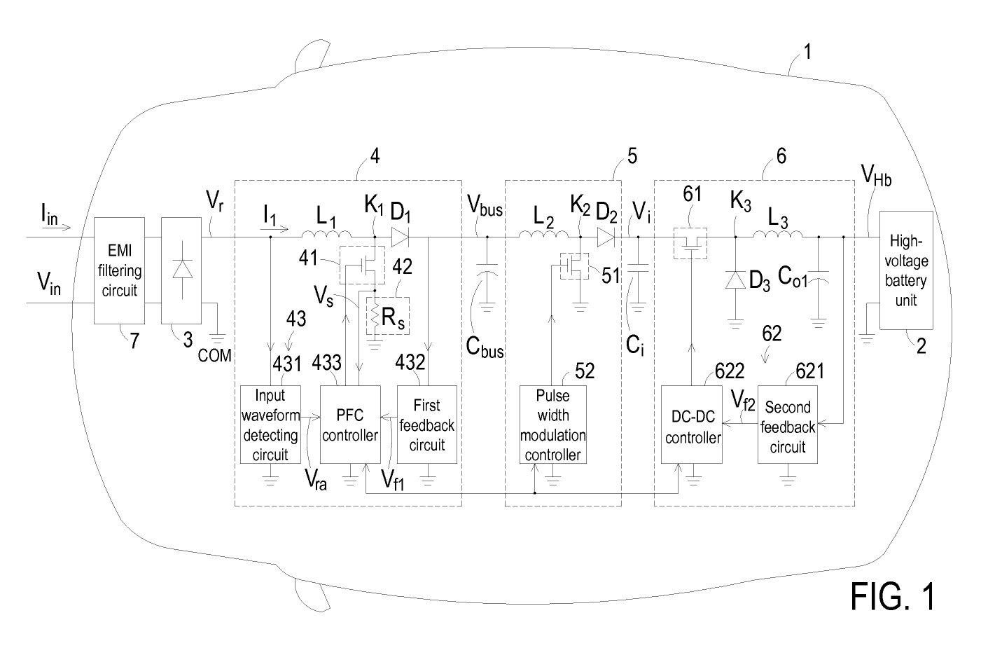

FIG. 1 is a schematic circuit block diagram illustrating the architecture of a high-voltage battery charging system according to an embodiment of the present invention. The high-voltage battery charging system is applied to and installed in an electric vehicle body 1. The high-voltage battery charging system is used for receiving electric energy of an AC input voltage Vᵢₙ from an utility power source, and charging a high-voltage battery unit 2. As shown in FIG. 1, the high-voltage battery charging system comprises a rectifier circuit 3, a power factor correction circuit 4, an intermediate non-isolated DC-DC converting circuit 5, a non-isolated DC-DC converting circuit 6, a bus capacitor C_{bus}, and an intermediate output capacitor Cᵢ.

In this embodiment, the high-voltage battery charging system further comprises an electromagnetic interference (EMI) filtering circuit 7. The EMI filtering circuit 7 is connected to the input terminal of the rectifier circuit 3 for filtering off the surge and high-frequency noise contained in the AC input voltage Vᵢₙ and the AC input current Iᵢₙ. In addition, the use of the EMI filtering circuit 7 can reduce the electromagnetic interference on the AC input voltage Vᵢₙ and the AC input current resulted from the switching circuits of the power factor correction circuit 4, the intermediate non-isolated DC-DC converting circuit 5 and the non-isolated DC-DC converting circuit 6. After the surge and high-frequency noise are filtered off by the EMI filtering circuit 7, the AC input voltage Vᵢₙ and the AC input current Iᵢₙ are transmitted to the input terminal of the rectifier circuit 3. The AC input voltage Vᵢₙ is rectified into a rectified voltage Vᵣ by the rectifier circuit 3.

The power factor correction circuit 4 is connected with the output terminal of the rectifier circuit 3 for increasing the power factor and generating a bus voltage V_{bus}. The bus capacitor C_{bus} is connected between the output terminal of the power factor correction circuit 4 and a common terminal COM for energy storage and voltage stabilization. An example of the bus capacitor C_{bus} includes but is not limited to an electrolytic capacitor.

The intermediate non-isolated DC-DC converting circuit 5 is connected with the output terminal of the power factor correction circuit 4 and the bus capacitor C_{bus}. The intermediate non-isolated DC-DC converting circuit 5 is used for increasing the bus voltage V_{bus} into an intermediate output voltage Vᵢ. The intermediate output capacitor Cᵢ is connected between the output terminal of the intermediate non-isolated DC-DC converting circuit 5 and the common terminal COM for energy storage and voltage stabilization. An example of the intermediate output capacitor Cᵢ includes but is not limited to a plastic capacitor. The non-isolated DC-DC converting circuit 6 is connected between the output terminal of the intermediate non-isolated DC-DC converting circuit 5, the intermediate output capacitor Cᵢ and the high-voltage battery unit 2. The non-isolated DC-DC converting circuit 6 is used for converting the intermediate output voltage Vᵢ into a high charging voltage V_{Hb}. The high-voltage battery unit 2 is charged by the high charging voltage V_{Hb}. In accordance with the present invention, no transformer is included in the electric energy paths of the intermediate non-isolated DC-DC converting circuit 5 and the non-isolated DC-DC converting circuit 6, so that the power loss is largely reduced. Moreover, by a switching circuit and an output filter circuit of the non-isolated DC-DC converting circuit 6, the high-voltage battery unit 2 is charged by the high charging voltage V_{Hb}.

In comparison with the conventional charger for an electric vehicle, the high-voltage battery charging system of the present invention further comprises the intermediate non-isolated DC-DC converting circuit 5. The intermediate non-isolated DC-DC converting circuit 5 is arranged between the power factor correction circuit 4 and the non-isolated DC-DC converting circuit 6. Since the input voltage (i.e. the bus voltage V_{bus}) received by the intermediate non-isolated DC-DC converting circuit 5 has been previously stored and stabilized by the bus capacitor C_{bus}, the intermediate output voltage Vᵢ is more stable than the bus voltage V_{bus}. Under this circumstance, the capacitance value of the intermediate output capacitor Cᵢ is lower than that of the bus capacitor C_{bus}, but the rated voltage value of the intermediate output capacitor Cᵢ is higher than the bus capacitor C_{bus}. An example of the intermediate output capacitor Cᵢ includes but is not limited to a plastic capacitor. Consequently, the non-isolated DC-DC converting circuit 6 can generate a wide range of the high charging voltage to charge the high-voltage battery unit 2.

In this embodiment, the magnitude of the AC input voltage Vᵢₙ is 110˜380 volts, the magnitude of the bus voltage V_{bus} is 350˜450V, the magnitude of the intermediate output voltage Vᵢ is for example 500V, and the magnitude of the high charging voltage V_{Hb} is 370˜450V. The capacitance value and the rated voltage value of the bus capacitor C_{bus} are 100 μF and 450V, respectively. The capacitance value and the rated voltage value of the intermediate output capacitor Cᵢ are 1˜3 μF and 630V, respectively. The rectifier circuit 3, the power factor correction circuit 4, the intermediate non-isolated DC-DC converting circuit 5, the non-isolated DC-DC converting circuit 6, the EMI filtering circuit 7 and the bus capacitor C_{bus}, the intermediate output capacitor Cᵢ and the high-voltage battery unit 2 are all operated at high voltage values. Consequently, the high-voltage battery charging system has low charging loss and short charging time during the charging process and has low power loss and enhanced efficiency during the electric vehicle is driven.

An example of the intermediate non-isolated DC-DC converting circuit 5 includes but is not limited to a boost non-isolated DC-DC converting circuit. An example of the non-isolated DC-DC converting circuit 6 includes but is not limited to a buck non-isolated DC-DC converting circuit, a buck-boost non-isolated DC-DC converting circuit or a boost non-isolated DC-DC converting circuit. An example of the power factor correction circuit 4 includes but is not limited to a continuous conduction mode (CCM) boost power factor correction circuit, a direct coupling modulated bias (DCMB) boost power factor correction circuit, a buck power factor correction circuit or a buck-boost power factor correction circuit. The high-voltage battery unit 2 includes one or more batteries such as lead-acid batteries, nickel-cadmium batteries, nickel iron batteries, nickel-metal hydride batteries, lithium-ion batteries, or a combination thereof.

As shown in FIG. 1, the power factor correction circuit 4 comprises a first inductor L₁, a first diode D₁ (a first rectifier element), a first switching circuit 41, a first current-detecting circuit 42, and a power factor correction controlling unit 43. A first terminal of the first inductor L₁ is connected to the input terminal of the power factor correction circuit 4. A second terminal of first inductor L₁ is connected to a first connecting node K₁. The first switching circuit 41 and the first current-detecting circuit 42 are serially connected between the first connecting node K₁ and the common terminal COM. The anode of the first diode D₁ is connected to the first connecting node K₁. The cathode of the first diode D₁ is connected to the output terminal of the power factor correction circuit 4. The power factor correction controlling unit 43 is connected to the common terminal COM, the positive output terminal of the rectifier circuit 3, the control terminal of the first switching circuit 41 and the first current-detecting circuit 42. The power factor correction controlling unit 43 is used for controlling operations of the power factor correction circuit 4.

In a case that the first switching circuit 41 is conducted, the first inductor L₁ is in a charging status and the magnitude of the first current I₁ is increased. The first current I₁ will be transmitted from the first inductor L₁ to the first current-detecting circuit 42 through the first switching circuit 41, so that a current-detecting signal Vₛ is generated by the first current-detecting circuit 42. Whereas, in a case that the first switching circuit 41 is shut off, the first inductor L₁ is in a discharging status and the magnitude of the first current I₁ is decreased. The first current I₁ will be transmitted to the bus capacitor C_{bus} through the first diode D₁.

In this embodiment, the power factor correction controlling unit 43 comprises an input waveform detecting circuit 431, a first feedback circuit 432, and a power factor correction controller 433. The input waveform detecting circuit 431 is connected to the input terminal of the power factor correction circuit 4, the power factor correction controller 433 and the common terminal COM. The input waveform detecting circuit 431 is used for reducing the magnitude of the rectified voltage Vᵣ and filtering off the high-frequency noise contained in the rectified voltage Vᵣ, thereby generating an input detecting signal Vᵣₐ. After the AC input voltage Vᵢₙ is rectified, the waveform of the input detecting signal Vᵣₐ is identical to that of the rectified AC input voltage Vᵢₙ. The first feedback circuit 432 is connected to the output terminal of the power factor correction circuit 4, the power factor correction controller 433 and the common terminal COM. The first feedback circuit 432 is used for performing voltage division on the bus voltage V_{bus}, thereby generating a first feedback signal V_{f1}.

In other words, the waveform of the AC input voltage Vᵢₙ is acquired by the power factor correction controller 433 according to the input detecting signal Vᵣₐ. According to the first feedback signal V_{f1}, the power factor correction controller 433 judges whether the bus voltage V_{bus} is maintained at the rated voltage value (e.g. 450V). According to the current-detecting signal Vₛ, the increase magnitude of the first current I₁ is detected so as to control the duty cycle of the first switching circuit 41. As a consequence, the bus voltage V_{bus} is maintained at the rated voltage value, and the distribution of the AC input current Iᵢₙ is similar to the waveform of the AC input voltage Vᵢₙ. Under this circumstance, a better power factor correction function is achieved.

In this embodiment, the intermediate non-isolated DC-DC converting circuit 5 is a single-phase non-isolated DC-DC converting circuit. The intermediate non-isolated DC-DC converting circuit 5 comprises a second inductor L₂, a second switching circuit 51, a second diode D₂ (a second rectifier element), and a pulse width modulation controller 52. A first terminal of the second inductor L₂ is connected with the input terminal of the intermediate non-isolated DC-DC converting circuit 5. A second terminal of the second inductor L₂ is connected with a second connecting node K₂. The second switching circuit 51 is connected between the second connecting node K₂ and the common terminal COM. The anode of the second diode D₂ is connected with the second connecting node K₂. The cathode of the second diode D₂ is connected with the output terminal of the intermediate non-isolated DC-DC converting circuit 5. The pulse width modulation controller 52 is connected with the common terminal COM and the control terminal of the second switching circuit 51 for controlling operations of the second switching circuit 51. Consequently, the bus voltage V_{bys} is converted into the intermediate output voltage Vᵢ by the intermediate non-isolated DC-DC converting circuit 5.

In this embodiment, the non-isolated DC-DC converting circuit 6 is a single-phase non-isolated DC-DC converting circuit. The non-isolated DC-DC converting circuit 6 comprises a third inductor L₃, a third diode D₃ (a third rectifier element), a first output capacitor Co₁, a third switching circuit 61 and a DC-DC controlling unit 62. The third inductor L₃ is connected between the third connecting node K₃ and the output terminal of the non-isolated DC-DC converting circuit 6. The third diode D₃ is connected between the third connecting node K₃ and the common terminal COM. The first output capacitor Co₁ is connected between the non-isolated DC-DC converting circuit 6 and the common terminal COM. The third switching circuit 61 is connected between the input terminal of the non-isolated DC-DC converting circuit 6 and the third connecting node K₃. The DC-DC controlling unit 62 is connected with the control terminal of the third switching circuit 61, the common terminal COM and the high-voltage battery unit 2. According to the high charging voltage V_{Hb}, the on/off statuses of the third switching circuit 61 are controlled by the DC-DC controlling unit 62.

In this embodiment, the DC-DC controlling unit 62 comprises a second feedback circuit 621 and a DC-DC controller 622. The second feedback circuit 621 is connected to the high-voltage battery unit 2, the DC-DC controller 622 and the common terminal COM. The second feedback circuit 621 is used for performing voltage division on the high charging voltage V_{Hb}, thereby generating a second feedback signal V_{f2}. The DC-DC controller 622 is connected to the control terminal of the third switching circuit 61, the second feedback circuit 621 and the common terminal COM. According to the second feedback signal V_{f2}, the DC-DC controller 622 judges whether the high charging voltage V_{Hb} is maintained at the rated voltage value (e.g. 400V). As a consequence, the duty cycle of the third switching circuit 61 is controlled, and the high charging voltage V_{Hb} is maintained at the rated voltage value.

The electric energy path of the non-isolated DC-DC converting circuit 6 is transmitted through the third switching circuit 61 and the third inductor L₃. In other words, no transformer is included in the non-isolated DC-DC converting circuit 6. In the non-isolated DC-DC converting circuit 6, a first output filter circuit is defined by the third inductor L₃ and the first output capacitor Co₁. The operations of the first output filter circuit and the third switching circuit 61 cause the high-voltage battery unit 2 to be charged by the high charging voltage V_{Hb}. That is, by the switching circuit and the output filter circuit of the non-isolated DC-DC converting circuit 6, the high-voltage battery unit 2 is charged by the high charging voltage V_{Hb}.

In the above embodiments, the rectifier circuit 3 is a bridge rectifier circuit. The positive output terminal of the rectifier circuit 3 is connected to the input terminal of the power factor correction circuit 4. The negative output terminal of the rectifier circuit 3 is connected to the common terminal COM. An example of the first current-detecting circuit 42 includes but is not limited to a current transformer or a detecting resistor R. Each of the first switching circuit 41, the second switching circuit 51 and the third switching circuit 61 includes one or more switch elements. The switch element is a metal oxide semiconductor field effect transistor (MOSFET), a bipolar junction transistor (BJT) or an insulated gate bipolar transistor (IGBT). In a preferred embodiment, each of the first switching circuit 41, the second switching circuit 51 and the third switching circuit 61 includes a metal oxide semiconductor field effect transistor (MOSFET). Moreover, each of the power factor correction controller 433 and the DC-DC controller 622 includes a controller, a micro controller unit (MCU) or a digital signal processor (DSP).

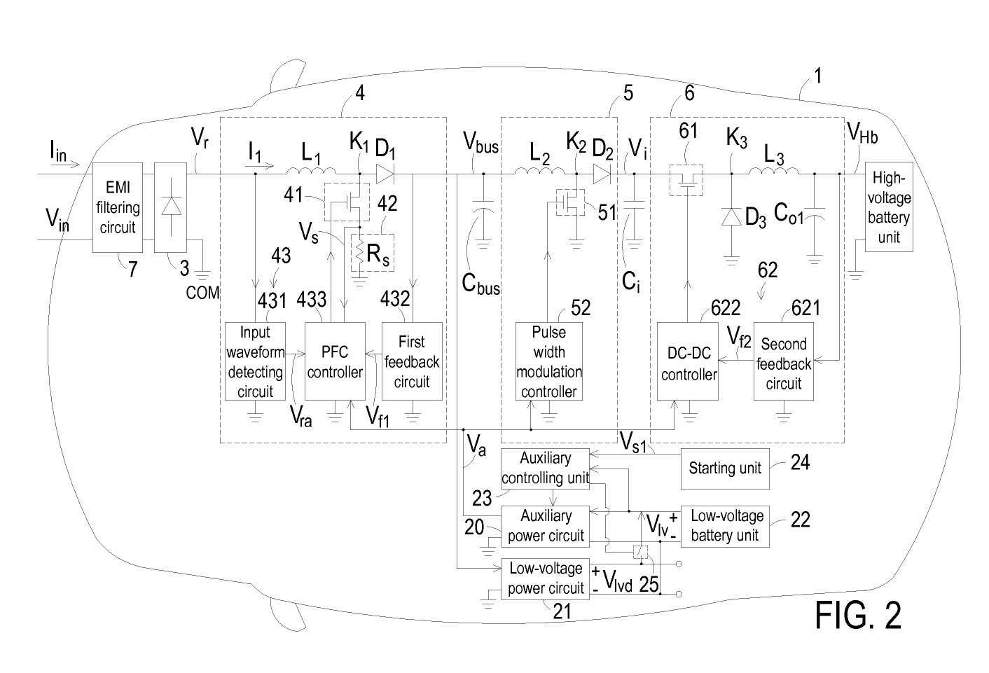

FIG. 2 is a schematic circuit block diagram illustrating the architecture of a high-voltage battery charging system according to another embodiment of the present invention. In comparison with FIG. 1, the high-voltage battery charging system of FIG. 2 further comprises an auxiliary power circuit 20, a low-voltage power circuit 21, a low-voltage battery unit 22, an auxiliary controlling unit 23, a starting unit 24, and a charge switching circuit 25. The low-voltage battery unit 22 is connected with the power input terminal of the auxiliary power circuit 20 for outputting a low voltage V₁ᵥ to the auxiliary power circuit 20. The power output terminal of the auxiliary power circuit 20 is connected with the power factor correction controller 433, the pulse width modulation controller 52, and the DC-DC controller 622. The auxiliary power circuit 20 is further connected with the common terminal COM. The auxiliary power circuit 20 is used for converting the low voltage V₁ᵥ into an auxiliary voltage Vₐ, thereby providing electric energy to the power factor correction controller 433, the pulse width modulation controller 52 and the DC-DC controller 622.

When the AC input voltage Vᵢₙ is received by the high-voltage battery charging system and the low-voltage battery unit 22 needs to be charged, the user may trigger the starting unit 24 to have the starting unit 24 issue a starting signal Vₛ₁. The auxiliary controlling unit 23 is connected with the starting unit 24, the auxiliary power circuit 20, the low-voltage battery unit 22 and the control terminal of the charge switching circuit 25. The auxiliary controlling unit 23 is powered by the low voltage V₁ᵥ. Moreover, the auxiliary controlling unit 23 is used for controlling operations of the auxiliary power circuit 20. Depending on the condition whether the starting signal Vₛ₁ is received or not, the auxiliary controlling unit 23 controls the on/off statuses of the charge switching circuit 25. The low-voltage power circuit 21 is connected with the output terminal of the power factor correction circuit 4 and the common terminal COM. The low-voltage power circuit 21 is used for receiving the bus voltage V_{bus} and converting the bus voltage V_{bus} into a low charging voltage V_{1vd} (e.g. 12V). The low charging voltage V_{1vd} may be used to power the components of the electric vehicle that are enabled by low voltage. The charge switching circuit 25 is connected between the low-voltage battery unit 22 and the output terminal of the low-voltage power circuit 21. Under control of the auxiliary controlling unit 23, the charge switching circuit 25 is selectively conducted or shut off. In a case that the charge switching circuit 25 is conducted, the low charging voltage V_{1vd} is transmitted from the low-voltage power circuit 21 to the low-voltage battery unit 22 through the charge switching circuit 25, thereby charging the low-voltage battery unit 22.

From the above descriptions, when the AC input voltage Vᵢₙ is received by the high-voltage battery charging system and the low-voltage battery unit 22 needs to be charged, the user may trigger the starting unit 24 to have the starting unit 24 issue a starting signal Vₛ₁. In response to the starting signal Vₛ₁, the charge switching circuit 25 is conducted under control of the auxiliary controlling unit 23. Consequently, the low charging voltage V_{1vd} is transmitted from the low-voltage power circuit 21 to the low-voltage battery unit 22 through the charge switching circuit 25, thereby charging the low-voltage battery unit 22.

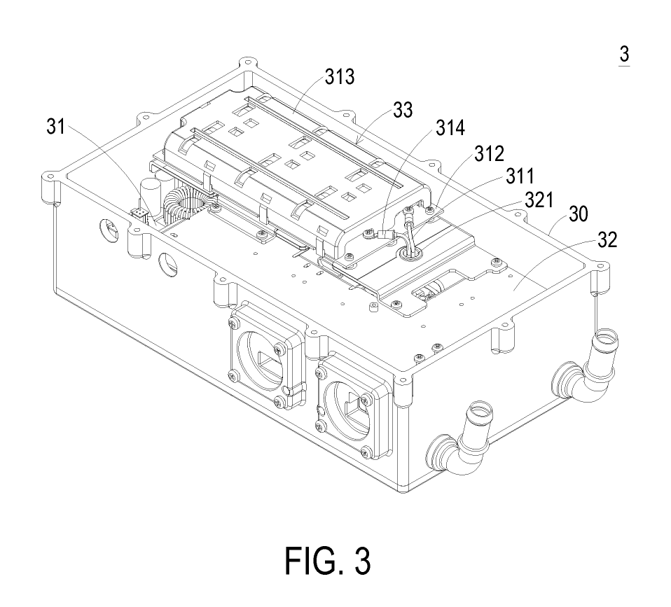

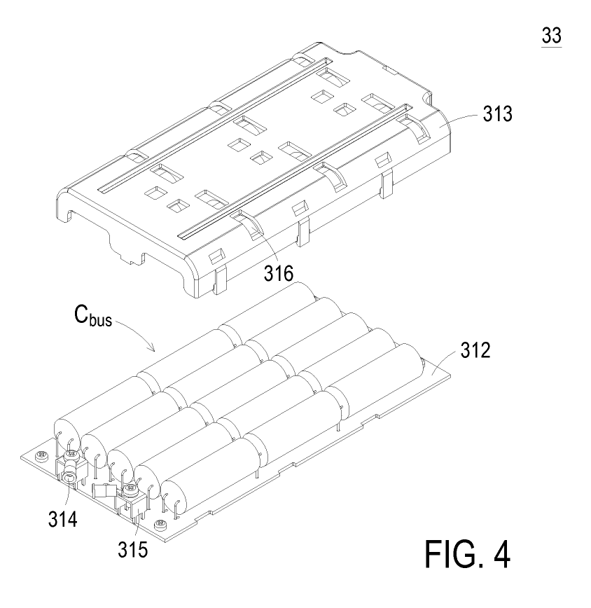

In some embodiments, the bus capacitor C_{bus} is replaceable. FIG. 3 is a schematic perspective view illustrating the outward appearance of a battery with a high-voltage battery charging system according to the present invention. FIG. 4 schematically illustrates a bus capacitor module of the battery as shown in FIG. 3. Please refer to FIGS. 1, 3 and 4. The charger 3 may be applied to and installed in an electric vehicle. The charger 3 comprises a charger body 30, a circuit board 31 and a partition plate assembly 32. The circuit board 31 is disposed within the charger body 30, and includes the high-voltage battery charging system as shown in FIG. 1 or FIG. 2. Moreover, the circuit board 31 has a first connecting part 311 which connects with the high-voltage battery charging system as shown in FIG. 1. That is, the first connecting part 311 is connected with the output terminal of the power factor correction circuit 4 and the intermediate non-isolated DC-DC converting circuit 5 of the high-voltage battery charging system. Moreover, the bus capacitor C_{bus}, a supporting plate 312, a covering member 313 and a second connecting part 314 are collaboratively defined as a bus capacitor module 33. The partition plate assembly 32 is disposed within the charger body 30 and over the circuit board 31 for partially enclosing the circuit board 31 within the charger body 30. Due to the partition plate assembly 32, the circuit board 31 is isolated from the outside surroundings of the charger body 30. In addition, the partition plate assembly 32 has a perforation 321. The first connecting part 311 is protruded out over the partition plate assembly 32 through the perforation 321.

The bus capacitor module 33 is replaceable, and fixed on the partition plate assembly 32 by a screwing means. The second connecting part 314 is detachably connected with the first connecting part 311. The bus capacitor C_{bus} comprises at least one electrolytic capacitor. Moreover, the bus capacitor C_{bus} may be welded on the supporting plate 312. The supporting plate 312 may be fixed on the partition plate assembly 32 by a screwing means. The second connecting part 314 is fixed on the supporting plate 312 by a fastening element 315. The fastening element 315 is made of conductive material. In addition, the fastening element 315 is inserted in the supporting plate 312. Through a trace pattern or a conductor line on the supporting plate 312, the fastening element 315 is electrically connected with the bus capacitor C_{bus}. Consequently, the second connecting part 314 is electrically connected with the bus capacitor C_{bus} through the fastening element 315. The supporting plate 312 is covered with the covering member 313 by fastening means, so that the bus capacitor C_{bus} is sheltered by the covering member 313. In some embodiments, the covering member 313 has the same number of slots 316 as the number of the electrolytic capacitors of the bus capacitor C_{bus}. After the supporting plate 312 is covered with the covering member 313, the slots 316 may partially accommodate corresponding electrolytic capacitors, thereby facilitating fixing the electrolytic capacitors.

As can be seen from FIGS. 3 and 4, after the bus capacitor C_{bus} of the high-voltage battery charging system is damaged or used for a long time period, the bus capacitor C_{bus} may be replaced with a new one. For replacing the bus capacitor C_{bus}, the first connecting part 311 and the second connecting part 314 are detached from each other, and then the bus capacitor module 33 is replaced with a new one. Since only the bus capacitor module is replaced, the charger of the present invention has low operating cost.

From the above descriptions, the present invention provides a high-voltage battery charging system for use in an electric vehicle and also a charger with such a high-voltage battery charging system. Due to the intermediate non-isolated DC-DC converting circuit, the intermediate output capacitor connected with the input terminal of the non-isolated DC-DC converting circuit has a higher rated voltage value. Consequently, the non-isolated DC-DC converting circuit will generate a wide range of the high charging voltage. Moreover, the auxiliary power circuit is powered by the low-voltage battery unit. Consequently, if the AC input voltage received by the high-voltage battery charging system is abnormal or interrupted, the auxiliary power circuit is normally operated to continuously deliver electric energy to various controlling units. Under this circumstance, since the functions of various controlling units of the electric vehicle can be continuously maintained, the reliability of the high-voltage battery charging system is enhanced. Moreover, the bus capacitor used in the high-voltage battery charging system of the present invention is replaceable. After the bus capacitor has been used for a long time period, the bus capacitor may be replaced with a new one without the need of changing the whole charger. In other words, the use of the charger of the present invention has good replacing convenience and is resource-saving.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A high-voltage battery charging system, comprising:
a rectifier circuit connected with a common terminal for rectifying an AC input voltage into a rectified voltage;
a power factor correction circuit connected to said rectifier circuit for increasing a power factor of said rectified voltage and generating a bus voltage;
a bus capacitor connected between an output terminal of said power factor correction circuit and said common terminal for energy storage and voltage stabilization;
an intermediate non-isolated DC-DC converting circuit connected with said output terminal of said power factor correction circuit and said bus capacitor for boosting said bus voltage into an intermediate output voltage;
an intermediate output capacitor connected between an output terminal of said intermediate non-isolated DC-DC converting circuit and said common terminal for energy storage and voltage stabilization; and
a non-isolated DC-DC converting circuit connected with said output terminal of said intermediate non-isolated DC-DC converting circuit, said intermediate output capacitor and a high-voltage battery unit for converting said intermediate output voltage into a high charging voltage, thereby charging said high-voltage battery unit.

2. The high-voltage battery charging system according to claim 1 wherein said high-voltage battery charging system is installed in a vehicle body of an electric vehicle, and said high-voltage battery unit is disposed within said vehicle body.

3. The high-voltage battery charging system according to claim 1 wherein said intermediate output capacitor has a rated voltage value higher than said bus capacitor.

4. The high-voltage battery charging system according to claim 3 wherein said bus capacitor is an electrolytic capacitor.

5. The high-voltage battery charging system according to claim 3 wherein said intermediate output capacitor is a plastic capacitor.

6. The high-voltage battery charging system according to claim 1 further comprising an electromagnetic interference filtering circuit, which is connected to said rectifier circuit for filtering off surge and high-frequency noise contained in said AC input voltage and an AC input current, and reducing adverse influence of electromagnetic interference on said AC input voltage when a switching circuit of said intermediate non-isolated DC-DC converting circuit, said non-isolated DC-DC converting circuit and said power factor correction circuit operates.

7. The high-voltage battery charging system according to claim 1 wherein said power factor correction circuit comprises:
a first inductor having a first terminal connected to an input terminal of said power factor correction circuit and a second terminal connected to a first connecting node;
a first rectifier element having a first terminal connected to said first connecting node and a second terminal connected to said output terminal of said power factor correction circuit;
a first current-detecting circuit for detecting a first current flowing through said first inductor, thereby generating a current-detecting signal;
a first switching circuit, wherein said first switching circuit and said first current-detecting circuit are serially connected between said first connecting node and said common terminal; and
a power factor correction controlling unit connected to said common terminal, said rectifier circuit, a control terminal of said first switching circuit and said first current-detecting circuit for controlling operations of said power factor correction circuit.

8. The high-voltage battery charging system according to claim 7 wherein said power factor correction controlling unit comprises:
an input waveform detecting circuit connected to said rectifier circuit and said common terminal for reducing a magnitude of said rectified voltage and filtering off high-frequency noise contained in said rectified voltage, thereby generating an input detecting signal, wherein a waveform of said input detecting signal is identical to a waveform of said AC input voltage after being rectified;
a first feedback circuit connected to said output terminal of said power factor correction circuit and said common terminal for performing voltage division on said bus voltage, thereby generating a first feedback signal; and
a power factor correction controller connected with said input waveform detecting circuit and said first feedback circuit for controlling a duty cycle of said first switching circuit according to said input detecting signal and said first feedback signal, so that said bus voltage is maintained at a rated voltage value and the distribution of said AC input current is similar to the waveform of said AC input voltage.

9. The high-voltage battery charging system according to claim 1 wherein said intermediate non-isolated DC-DC converting circuit comprises:
a second inductor having a first terminal connected to an input terminal of said intermediate non-isolated DC-DC converting circuit and a second terminal connected to a second connecting node;
a second rectifier element having a first terminal connected to said second connecting node and a second terminal connected to said output terminal of said intermediate non-isolated DC-DC converting circuit;
a second switching circuit connected between said second connecting node and said common node; and
a pulse width modulation controller connected with said common terminal and a control terminal of said second switching circuit for controlling on/off statuses of said second switching circuit, so that said bus voltage is converted into said intermediate output voltage by said intermediate non-isolated DC-DC converting circuit.

10. The high-voltage battery charging system according to claim 1 wherein said non-isolated DC-DC converting circuit comprises:
a third inductor connected between a third connecting node and an output terminal of said non-isolated DC-DC converting circuit;
a third rectifier element connected between said third connecting node and said common terminal;
a first output capacitor connected between said output terminal of said non-isolated DC-DC converting circuit and said common terminal;
a third switching circuit connected between an input terminal of said non-isolated DC-DC converting circuit and said third connecting node; and
a DC-DC controlling unit connected to a control terminal of said third switching circuit, said common terminal and said high-voltage battery unit for controlling on/off statuses of said third switching circuit according to said high charging voltage.

11. The high-voltage battery charging system according to claim 10 wherein said DC-DC controlling unit comprises:
a second feedback circuit connected to said high-voltage battery unit and said common terminal for performing voltage division on said high charging voltage, thereby generating a second feedback signal; and
a DC-DC controller connected to said control terminal of said third switching circuit, said second feedback circuit and said common terminal, wherein said DC-DC controller judges whether said high charging voltage is maintained at a rated voltage value according to said second feedback signal, so that a duty cycle of said third switching circuit is controlled and said high charging voltage is maintained at said rated voltage value.

12. The high-voltage battery charging system according to claim 1 further comprising:
a low-voltage battery unit for providing a low voltage; and
an auxiliary power circuit for converting said low voltage into an auxiliary voltage, thereby providing electric energy to said power factor correction circuit, said intermediate non-isolated DC-DC converting circuit and said non-isolated DC-DC converting circuit, wherein a power input terminal of said auxiliary power circuit is connected with said low-voltage battery unit for receiving said low voltage, and power output terminal of said auxiliary power circuit is connected with said power factor correction circuit, said intermediate non-isolated DC-DC converting circuit and said non-isolated DC-DC converting circuit.

13. The high-voltage battery charging system according to claim 12 further comprising:
a starting unit, wherein when said AC input voltage is received by said high-voltage battery charging system, said starting unit is triggered to issue starting signal when said low-voltage battery unit needs to be charged;
a low-voltage power circuit connected with said output terminal of the power factor correction circuit and said common terminal for receiving said bus voltage and converting said bus voltage into a low charging voltage;
a charge switching circuit connected between said low-voltage battery unit and an output terminal of said low-voltage power circuit for controlling on/off statuses; and
an auxiliary controlling unit for controlling operation of said auxiliary power circuit, wherein said auxiliary controlling unit is connected with said starting unit, said auxiliary power circuit, said low-voltage battery unit and a control terminal of said charge switching circuit, and powered by said low voltage, wherein said auxiliary controlling unit controls on/off statuses of the charge switching circuit according to said starting signal, such that said low-voltage battery unit can be charged by said low charging voltage through said charge switching circuit when the said charge switching circuit is conducted.

14. A charger for use in an electric vehicle, said charger comprising:
a charger body;
a partition plate assembly disposed within said charger body, and having a perforation; and
a circuit board partially enclosed within said charger body through said partition plate assembly, and comprising a first connecting part and said high-voltage battery charging system according to claim 1, wherein said bus capacitor of said high-voltage battery charging system, a supporting plate, a covering member and a second connecting part are collaboratively defined as a replaceable bus capacitor module, wherein said supporting plate is disposed on said partition plate assembly, said second connecting part is electrically connected with said bus capacitor and detachably connected with said first connecting part, said covering member is disposed on said supporting plate for sheltering said bus capacitor, said first connecting part is protruded out over said partition plate assembly through said perforation, and said first connecting part is connected with said output terminal of said power factor correction circuit and said intermediate non-isolated DC-DC converting circuit,
wherein for replacing said bus capacitor, said first connecting part is detached from said second connecting part and said bus capacitor module with a new one.

15. The charger according to claim 14 wherein a fastening element is inserted into said supporting plate and electrically connected with said bus capacitor, wherein said second connecting part is fixed on said supporting part through said fastening element, so that said second connecting part is electrically connected with said bus capacitor through said fastening element.

16. The charger according to claim 14 wherein said supporting plate is covered with said covering member by fastening means.
